(19) United States
(12) Patent Application Publication
(10) Pub. No.: US 2024/0146215 A1
(43) Pub. Date: May 2, 2024

(54) MOTOR DRIVE DEVICE COMPRISING FAN MOTOR AND METHOD FOR CONTROLLING MOTOR DRIVE DEVICE

(71) Applicant: FANUC CORPORATION, Yamanashi (JP)

(72) Inventor: Nagomu FUJIWARA, Yamanashi (JP)

(21) Appl. No.: 18/556,289

(22) PCT Filed: Apr. 27, 2021
(86) PCT No.: PCT/JP2021/016856

§ 371 Date: Oct. 19, 2023

(51) Int. Cl. H02P 1/02; F28F 27/00

(52) U.S. Cl. CPC H02P 1/029; F28F 27/00

(57) ABSTRACT

The present invention provides a motor drive device comprising a means for restarting, with a simple configuration, a fan motor that is stuck due to dirt, and a method for controlling said motor drive device. This motor drive device 10 comprises a body 14 having an electronic component 12 inside, a heat radiator 16 attached to the body 14, and external fan motor 18 attached to the heat radiator 16, and an internal fan motor 20 provided inside the body 14. The electronic component 12 includes a processor for controlling the motor for driving a machine tool or a robot, memory, a control circuit, etc., and functions as a restart unit for a fan motor that is stuck due to dirt.

### TECHNICAL FIELD

The present invention relates to a motor drive device having a fan motor, and a method for controlling the motor drive device.

### BACKGROUND ART

Motor drive devices such as servo amplifiers used in machine tools and robots may generate heat during use and not operate normally. Therefore, in many cases, a fan motor is provided in the motor drive device to cool the motor drive device.

When the fan motor attached to the motor drive device is operated for a long period of time in a factory, etc., various dirt or contaminants (such as cutting fluid and chips) in the factory adhere to blades and spokes of the fan motor and accumulate thereon. When the motor drive device is turned off once after the amount of dirt exceeds a certain amount, and then the motor is restarted, the blades of the fan motor may become stuck due to the dirt and stop rotating. This is not due to damage to the electrical circuitry or internal structure of the fan motor, but because the highly viscous contaminants create high friction and prevent the blades from rotating.

As a technique for restarting a fan motor which is stuck due to contamination, there is known a technique for restarting the fan motor by torque-up or forward/reverse rotation (e.g., refer to Patent Literature 1). Also, there is known a technique of rotating an impeller by connecting the impeller to a rotor when the fan motor stops due to sticking, etc. (e.g., refer to Patent Literature 2). Further, there is known a technique of ejecting compressed air from a nozzle provided in the vicinity of a fan motor to remove dirt adhering to the fan motor (e.g., refer to Patent Literature 3).

### CITATION LIST

### Patent Literature

[PTL 1] JP 2015-146715 A
[PTL 2] JP 2017-225292 A
[PTL 3] JP 2014-136997 A

### SUMMARY OF INVENTION

### Technical Problem

In the prior art, when a fan motor has become stuck due to contamination, it is necessary to replace the fan each time it becomes stuck. In addition, when it is necessary to quickly activate a machine tool, etc., an operator directly applies an external force to blades of the fan motor so as to restart the fan motor. In both cases, this has been a factor in lowering the operating rate of the machine tool, etc.

On the other hand, there are several known techniques for restarting the fan motor without replacing the fan and without directly applying an external force to the fan motor by the operator.

However, these technologies require unusual operations and/or the provision of special or dedicated structures for restarting, leading to increased fan motor costs.

### Solution to Problem

One aspect of the present disclosure is a motor drive device having a fan motor, comprising: a restarting unit configured to restart the fan motor by intermittently supplying a current lower than a current during normal use of the fan motor to the fan motor which is stuck due to adhesion or accumulation of dirt.

Another aspect of the present disclosure is a method for controlling a motor drive device having a fan motor, the method comprising the step of: restarting the fan motor by intermittently supplying a current lower than a current during normal use of the fan motor to the fan motor which is stuck due to adhesion or accumulation of dirt.

### Advantageous Effects of Invention

According to the present disclosure, the fan motor stuck due to dirt or contamination can be easily restarted by a simple means. Therefore, the operating rate of the machine tool, etc., equipped with the motor drive device can be prevented from being lowered without greatly increasing the cost of the motor drive device.

### BRIEF DESCRIPTION OF DRAWINGS

FIG. 1 is a schematic perspective view of a motor drive device according to an embodiment.

FIG. 2 is a graph showing an example in which the number of rotations of a fan motor is controlled by PWM.

FIG. 3 is a perspective view of an example in which a mechanism for applying an external force to a blade of the fan motor is provided to a body of the motor drive device.

FIG. 4 is a view of the mechanism of FIG. 3 as viewed from above the fan motor.

FIG. 5 is a view of an example in which a mechanism for applying an external force to the blade of the fan motor is provided to a casing of the fan motor.

FIG. 6 is a view showing a state in which the mechanism of FIG. 5 pushes the blade of the fan motor.

FIG. 7 is a view showing an example of a mechanism for transmitting power between two fan motors.

FIG. 8 is a view showing an example of a unitized fan motor.

FIG. 9 is a view showing an example in which the fan motor is fixed by a screw.

FIG. 10 is view showing an example in which the fan motor is fixed by a clamp.

FIG. 11 is view showing an example in which a heat source is provided to a stator of the fan motor.

FIG. 12 is view showing an example in which a heat source is provided in a casing of the fan motor.

FIG. 13 is a view showing an example in which a heat source is provided to an outer side part of the fan motor.

FIG. 14 is a view showing an example of a structure for applying cleaning fluid to the fan motor.

### DESCRIPTION OF EMBODIMENTS

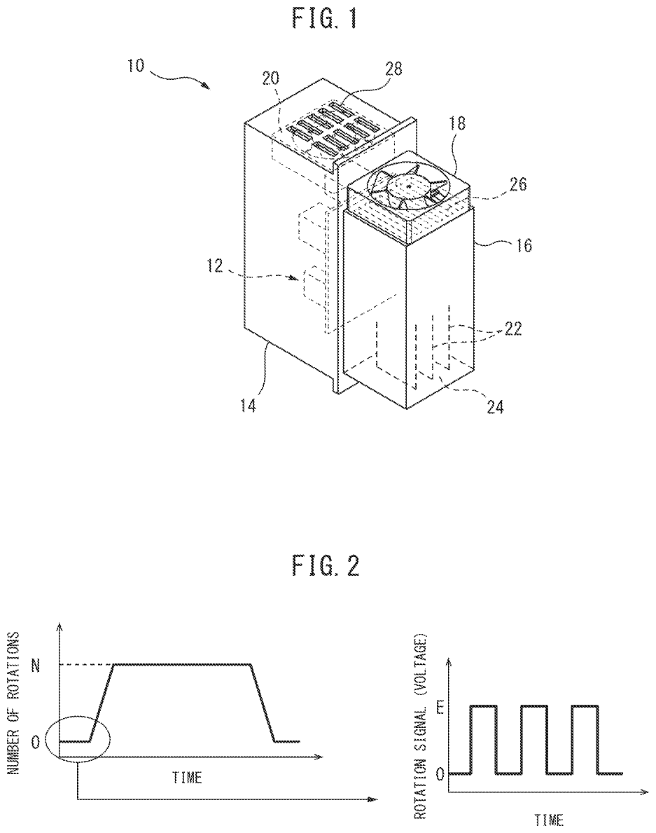

FIG. 1 is a perspective view of a motor drive device according to a preferred embodiment. For example, a motor drive device 10 is a servo amplifier for driving each axis of a machine tool, and has a case (main body) 14 in which an electronic component 12 is provided, a heat radiator 16 attached to the main body 14, a first (external) fan motor 18 attached to the heat radiator 16, and a second (internal) fan motor 20 provided inside the main body 14. The electronic component 12 includes a processor, a memory and a control circuit, etc., for controlling a drive motor (e.g., a servo motor) of a machine tool or a robot. The electronic component 12 also has a function of detecting a rotation speed of the fan motor based on an output, etc., of an encoder (not shown), and also may function as a detection unit configured to detect that the rotation of the fan motor 18 has slowed down or stopped (does not rotate) due to sticking caused by dirt or contamination. In Examples 1 to 3 described below, the electronic component 12 also functions as a restarting unit for the fan motor stuck due to contamination.

Inside the heat radiator 16, a plurality of heat radiation fins 22 are provided which are spaced apart from each other and extend parallel to each other and which are thermally connected to the electronic component 12. The external fan motor 18 is attached to an upper surface of the heat radiator 16 having an exhaust port 26 formed thereon. When the external fan motor 18 rotates, an airflow is generated from an intake port 24 formed at the bottom of the heat radiator 16 to the exhaust port 26, and the heat of the electronic component 12 is radiated to the outside through the heat radiating fins 22 by the airflow.

The internal fan motor 20 is mounted on an upper surface of the main body 14 having an exhaust port 28 formed thereon. When the internal fan motor 20 rotates, an airflow is generated from air intake port (not shown) formed at the bottom of the main body 14 to an exhaust port 28, and the heat of the electronic component 12 is radiated to the outside by the airflow.

In the present disclosure, the heat radiator 16 is not essential, and in examples other than a sixth example described below, at least one fan motor is sufficient, and it is not necessary to provide a plurality of fan motors. In the examples described below, it is assumed that the first fan motor 18, which is more susceptible to dirt than the second fan motor 20 inside the main body, is stuck due to dirt, and the means for restarting the first fan motor will be described. However, it is also possible to use this means to restart the internal fan motor 20.

### First Example

The electronic component 12, etc., generates and transmits a command to the fan motor 18 by which a circuit system inside the motor drive device 10 intermittently applies a current to the fan motor 18 for a predetermined period of time (e.g., within 5 seconds or within 10 seconds) after the motor drive device 10 is powered on. By virtue of this, it is possible to repetitively apply a rotational torque to the fan motor 18, and rotate the fan motor 18 stuck due to dirt, etc. In general, when a fan motor is stuck due to dirt, if a normal start-up operation (i.e., continuous current flow) is performed, the fan motor rotates only for a moment when the power is turned on, and then stops rotating even through the power is on. However, in the first example, since the current is intermittently applied to the fan motor 18, the operation of rotating only for a moment is repeated, which reduces the viscosity and coefficient of friction of the dirt, and eventually the rotational torque exceeds the frictional force of the dirt, allowing the fan motor 18 to rotate continuously.

In the first example, by repeatedly applying the rotational torque to the fan motor, the viscosity of dirt and the coefficient of friction can be reduced, the current intermittently supplied to the fan motor 18 may be less than the current during normal use. In other words, there is no need to supply a higher current than usual and to rotate the fan motor 18 in forward and reverse directions. Therefore, in the first example, there is no need to change the design or specifications, such as increasing the wire diameter of a coil to allow a larger current than usual to flow, or to provide the motor drive device with a dedicated circuit, etc., for forward/reverse rotation. The same is also applicable to second and third examples described below.

### Second Example

When the motor drive device 10 is compatible with PWM (pulse width modulation) control, the number of rotations of the fan motor 18 can be controlled by the PWM control. For example, when the number of rotations of the fan motor 18 should be increased from zero to N as shown in the graph on the left side of FIG. 2, the PWM control which repeats on-duty at 100% and 0% of the rotation speed, for example, provides an effect equivalent to repeatedly applying rotational torque. The second example does not require additional circuits or the like, and can be realized simply by changing the control.

### Third Example

When the power source, etc., of the motor drive device 10 is interlocked with a power source, etc., of the machine such as the machine tool or the robot, in which the motor drive device 10 is provided, by repeatedly turning on/off the power of the machine, an effect equivalent to that of repeatedly applying rotational torque can be obtained. This operation may be performed manually by an operator, or may be performed automatically.

As described above, each of the first to third examples has the means for intermittently supplying the current (rated current, etc.) lower than that during normal use to the fan motor 18. In this context, the normal use means essential use based on the specifications of the fan motor 18, and does not include an increase in torque (current) for forcibly rotating from the stuck state, and forward/reverse rotation, etc. According to the first to third examples, even when there is no abnormality or damage in the electric circuit or structure of the fan motor, the state in which the fan motor 18 cannot be started due to large friction caused by highly viscous dirt can be easily resolved at low cost. The operation for intermittently supplying the current may be performed each time the motor drive device is activated. Alternatively, the operation may be performed when it is detected that the fan motor 18 is stuck (when the fan motor 18 does not rotate even when the power is turned on), or when a sign of sticking of the fan motor 18 (e.g., a decrease in the rotation speed) is detected.

### Fourth Example

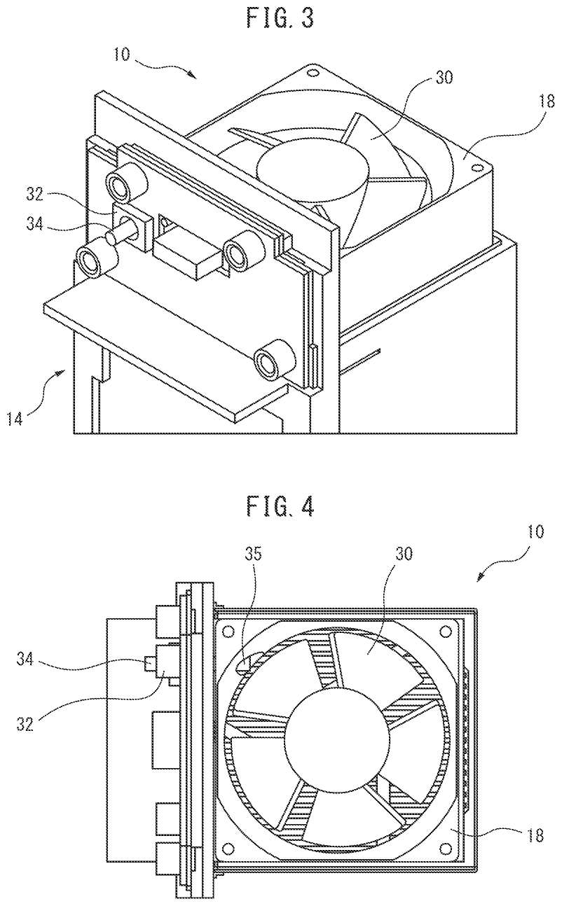

In a fourth example shown in FIGS. 3 and 4, an external force applying mechanism 32 configured to automatically apply an external force to a blade 30 of the fan motor 18 is mounted on the main body 14. In the illustrated example, the external force applying mechanism 32 is a solenoid using an electromagnet, and a tip 35 of a rod-shaped member 34 configured to be able to contact and separate from the blade 30 by turning the electromagnet on and off contacts the blade 30, whereby an external force (rotational torque) is applied to the blade 30. By virtue of this, a torque exceeding the static frictional force between (the blade 30 of) the fan motor 18 and the dirt can be applied to the blade 30, thereby the fan motor 18 can be rotated.

In this regard, the solenoid 32 can be configured to automatically activate. As for the operation condition of the solenoid 32, for example, the solenoid 32 may be operated each time the motor drive device 10 is activated, or when the fan motor 18 is detected to be stuck. Further, instead of the solenoid 32, a mechanical structure may be used in which a protrusion such as a rod-shaped member 34 is configured to be able to contact and separate from the blade 30.

### Fifth Example

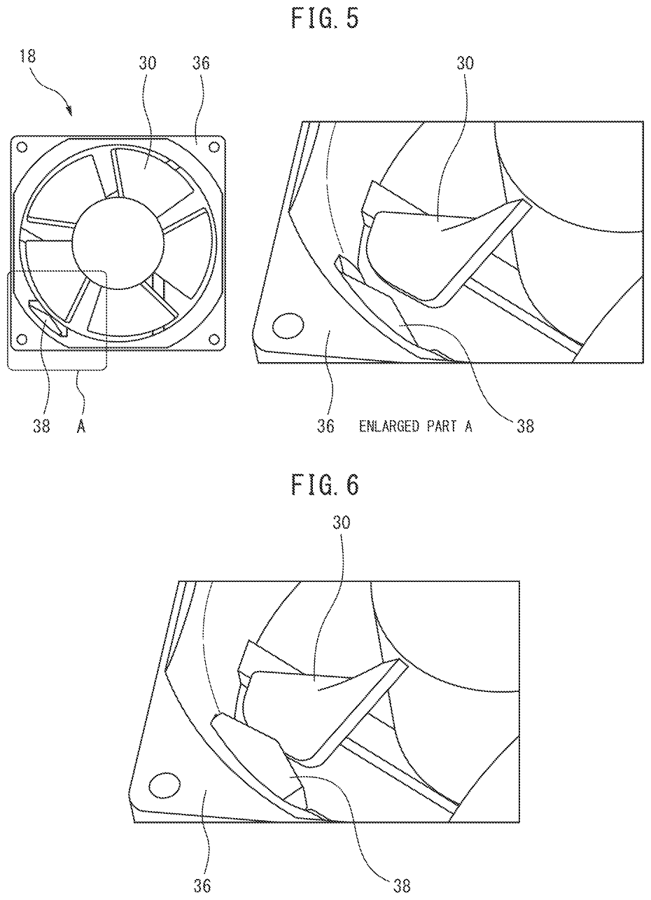

A fifth example shown in FIGS. 5 and 6 is the same as the fourth example in that the fifth example has a mechanism configured to be able to contact and separate from the blade 30 so as to apply the external force to the fan motor 18. However, the fifth example is different from the fourth example in that the external force applying mechanism (such as the solenoid 32) is provided in a case 36 of the fan motor 18, whereas the external force applying mechanism in the fourth example is provided in the main body 14.

Concretely, as shown in FIG. 5, by providing a mechanism configured to automatically project and retract a protrusions 38 incorporated in the case 36 from the inner surface of the case 36, the same effect as the fourth example can be obtained. As a means for driving the protrusion 38, a solenoid can be used as in the fourth example, but other mechanical structures may also be used.

### Sixth Example

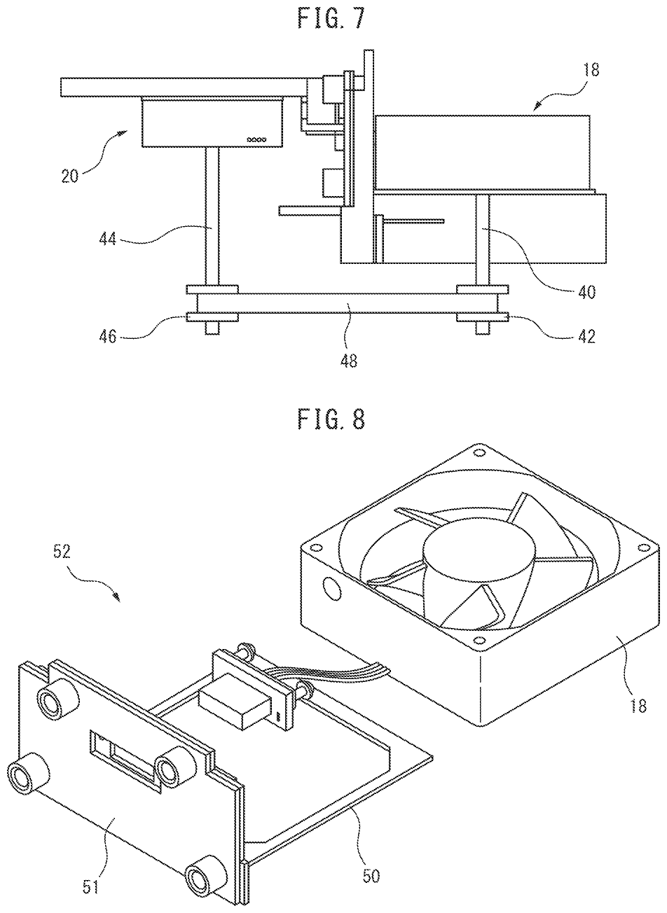

A sixth example shown in FIG. 7 has a mechanism configured to transmit power (rotational torque) of the internal fan motor 20 to the external fan motor 18. Specifically, by connecting a first pulley 42 attached to a rotation shaft 40 of the fan motor 18 and a second pulley 46 attached to a rotation shaft 44 of the fan motor 20 with a belt 48, etc., the power (rotational torque) of the internal fan motor 20 can be transmitted to the external fan motor 18. By virtue of this, even when the external fan motor 18 is stuck due to dirt or contamination, it is possible to utilize the power of the internal fan motor 20, which does not easily become dirty, to apply rotational torque to the external fan motor 18 and rotate it.

### Seventh Example

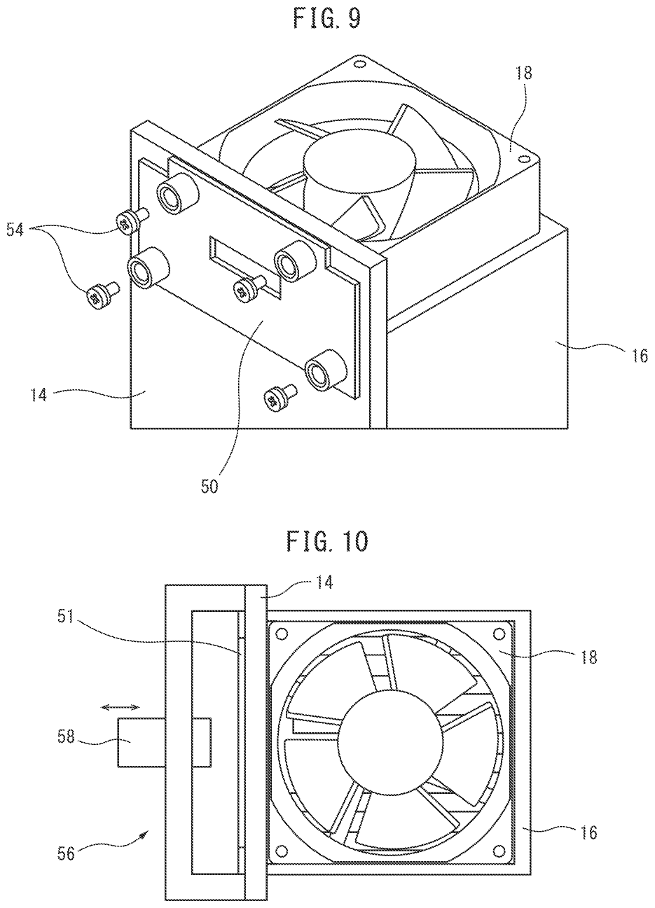

A seventh example shown in FIGS. 8 and 9 has a means for loosely securing a fan motor unit 52 to the main body 14. Concretely, as shown in FIG. 8, the fan motor 18 is fixed to a metal plate 50 with a screw, etc., and a cover 51 is fixed to the metal plate 50 so as to form the fan motor unit 52. Then, as shown in FIG. 9, the fan motor unit 52 is fixed to the main body 14 with a fastening means 54 such as a screw or bolt).

In this regard, when the electronic component 12 detects a sign (e.g., a decrease in rotation speed) that the fan motor 18 is stuck due to dirt, the screw or bolt 54 may be loosened to intentionally cause rattling between the members, thereby the fan motor unit 52 can be vibrated by the rotation of the fan motor 18. By this vibration, it is possible to shake off the dirt which may cause sticking, or to change the state of the dirt to reduce the static frictional force between the dirt and the blade 30. The operation of loosening the screw 54 may be performed by the operator at a predetermined timing (described later), such as when the sign of sticking of the fan motor 18 is detected, or a proper automated machine (not shown) may be used. When the automated machine is used, the loose screw 54 may be tightened when the fan motor 18 begins to rotate.

### Eighth Example

An eighth example shown in FIG. 10 is the same as the seventh example in that the coupling between the members is loosened to intentionally generate vibration, but is different in that a clamp 56 is used as a means for fixing the members. The clamp 56 has a rod-shaped member 58 configured to be displaced by an electromagnet, etc. By gripping the cover 51 which is a part of the fan motor unit 52 by using the rod-shaped member 58, the fan motor unit 52 is fixed to the main body 14.

In this regard, by separating the rod-shaped member 58 from the cover 51 and loosening the coupling between the members, rattling occurs between the members and the fan motor 18 can be vibrated, as in the seventh example. Also in the eighth example, it is possible to loosen the clamp 56 at a predetermined timing, such as when the fan motor 18 is detected to be stuck, and to tighten the clamp 56 when the fan motor 18 starts to rotate. Further, such operations can be automated.

### Ninth Example

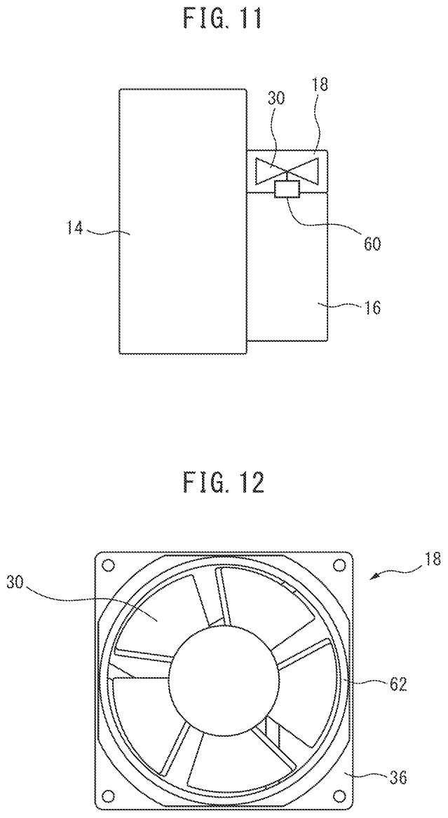

A ninth example shown in FIGS. 11 to 13 includes a means for removing dirt adhering to the fan motor 18 by heating at a predetermined timing. Concretely, as shown in FIG. 11, a heating unit (heat source) 60 is provided on or near the stator of the fan motor 18, and the heat source 60 is automatically activated when the fan motor 18 is stuck due to dirt or a sign thereof is detected, thereby heating the dirt adhering to the fan motor 18. Normally, the dirt adhering to the fan motor 18 is solidified, but is softened or liquefied by being heated. Therefore, the viscosity or frictional force of the dirt is reduced, making it easier to restart the fan motor 18.

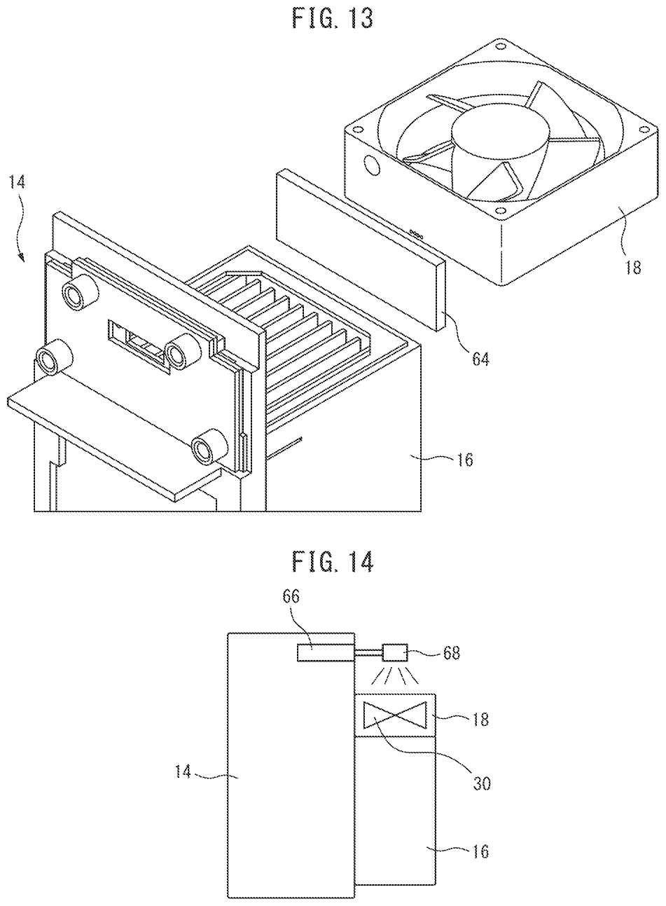

FIG. 12 shows an example in which a heat source 62 is provided along the inner surface of the case 36 of the fan motor 18, and FIG. 13 shows an example in which a heat source 64 is provided between the fan motor 18 and the main body 14. Similarly to the heat source 60, the heat sources 62 and 64 can be automatically activated when the fan motor 18 is stuck due to dirt or a sign thereof is detected, so that the dirt adhering to the fan motor 18 can be heated. When the heat source is used in this way, it is preferable to appropriately select the installation position of the heat source according to the part where dirt tends to adhere. Various types of heat sources can be used, including a coil heater, a band heater, a ribbon heater, and a cord heater.

### Tenth Example

A tenth example shown in FIG. 14 includes a means for physically or chemically removing dirt adhering to the fan motor 18 using a fluid, especially a cleaning liquid. Concretely, a container 66 containing the cleaning liquid is provided at an appropriate location (here, inside the main body 14). Then, by applying (spraying, dripping, etc.) the cleaning liquid to the fan motor 18 at a predetermined timing using a pump, etc. (not shown) from a discharge part such as a nozzle 68 fluidly connected to the container 66, the dirt adhering to the fan motor 18 can be physically blown off or chemically decomposed and washed away. In addition, a tray, etc. (not shown) may be provided below the fan motor 18 in order to collect the removed dirt and cleaning liquid.

In the tenth example, similarly to the ninth example, the cleaning of the fan motor 18 with the fluid can be automatically performed at a predetermined timing, such as when the fan motor 18 is stuck due to dirt or a sign thereof is detected. Further, the predetermined timing in the seventh to tenth examples may be the time when the fan motor 18 is stuck or a sign thereof is detected by the detection unit. Alternatively, the cumulative operation time of the fan motor 18 after the fan motor 18 is replaced or cleaned may be measured by a proper timer, etc., and the predetermined timing may be the time when the cumulative operating time reaches a predetermined value such as three months, six months or one year. As such, the predetermined timing is preferably a time point when the fan motor 18 is stuck or is likely to be stuck due to dirt.

It will be readily understood by those skilled in the art that the above examples can be combined, as appropriate. For example, the means for intermittently applying current as in the first example and the external force applying mechanism as in the fourth example may be combined, as may also the dirt removing mechanism as in the ninth or tenth example.

### REFERENCE SIGNS LIST

10 motor drive device
12 electronic component
14 main body
16 heat radiator
18 first fan motor
20 second fan motor
22 heat radiating fin
30 blade
32 solenoid
34, 38 protrusion
36 case
38 protrusion
40, 44 rotation shaft
42, 46 pulley
48 belt
50 metal plate
52 fan motor unit
34 screw
56 clamp
58 rod-shaped member
60, 62, 64 heat source
66 container
68 nozzle

1. A motor drive device having a fan motor, comprising:
a restarting unit configured to restart the fan motor by intermittently supplying a current lower than a current during normal use of the fan motor to the fan motor which is stuck due to adhesion or accumulation of dirt.

2. The motor drive device according to claim 1, wherein the restarting unit is configured to intermittently supply the current to the fan motor by means of a circuit system inside the motor drive device for a predetermined period of time after power-on of the motor drive device.

3. The motor drive device according to claim 1, wherein the restarting unit is configured to control a rotation speed of the fan motor by PWM control.

4. The motor drive device according to claim 1, wherein the restarting unit is configured to repeatedly turn ON/OFF power of a machine to which the motor drive device is attached.

5. The motor drive device according to claim 1, wherein the restarting unit has an external force applying mechanism configured to restart the fan motor by applying an external force to the fan motor.

6. The motor drive device according to claim 5, wherein the external force applying mechanism is configured to be capable of automatically contacting and separating from a blade of the fan motor, and imparting a rotational driving force to the fan motor.

7. The motor drive device according to claim 5, wherein the motor drive device includes a first fan motor and a second fan motor, and wherein the external force applying mechanism is configured to transmit a torque of the first fan motor to the second fan motor.

8. The motor drive device according to claim 1, wherein the motor drive device includes a means configured to apply vibration to a fan motor unit having the fan motor by loosening coupling between members of the fan motor unit at a predetermined timing, and restart the fan motor.

9. The motor drive device according to claim 1, wherein the motor drive device includes a dirt removal mechanism configured to restart the fan motor by removing dirt from the fan motor at a predetermined timing.

10. The motor drive device according to claim 9, wherein the dirt removal mechanism has a heating unit configured to heat the fan motor.

11. The motor drive device according to claim 9, wherein the dirt removal mechanism has an injection unit configured to inject fluid to the fan motor so as to physically or chemically remove the dirt.

12. The motor drive device according to claim 8, further comprising a detection unit configured to detect sticking of the fan motor or a sign thereof, wherein the predetermined timing is when the detection unit detects sticking of the fan motor or a sign thereof.

13. The motor drive device according to claim 8, wherein the predetermined timing is when a cumulative operating time of the fan motor after replacement or cleaning of the fan motor reaches a predetermined value.

14. A method for controlling a motor drive device having a fan motor, the method comprising the step of:
restarting the fan motor by intermittently supplying a current lower than a current during normal use of the fan motor to the fan motor which is stuck due to adhesion or accumulation of dirt.
